(19) United States
(12) Patent Application Publication
(10) Pub. No.: US 2012/0295159 A1
(43) Pub. Date: Nov. 22, 2012

(54) LITHIUM ION SECONDARY BATTERY NEGATIVE ELECTRODE SLURRY COMPOSITION, A LITHIUM ION SECONDARY BATTERY NEGATIVE ELECTRODE, AND LITHIUM ION SECONDARY BATTERY

(76) Inventor: Kei Kobayashi, Katsushika-ku (JP)

(21) Appl. No.: 13/576,899

(22) PCT Filed: Feb. 3, 2011
(86) PCT No.: PCT/JP2011/052216

§ 371 Date: Aug. 2, 2012

(30) Foreign Application Priority Data
Feb. 3, 2010 (JP) 2010-021827

(51) Int. Cl. H01M 4/64; H01M 4/04

(52) U.S. Cl. 429/211; 252/182.1; 427/122

(57) ABSTRACT

A lithium ion secondary battery negative electrode slurry composition comprising a negative electrode active material, a thickening agent, a binder of polymer particles and water, wherein the negative electrode active material includes a carbon material and the carbon material has a graphite interlayer distance (an interplanar spacing (d value) of the (002) plane as determined by an X-ray diffraction method) of 0.340 to 0.370 nm, the thickening agent is a polymer having a degree of polymerization of 1400 to 3000, the polymer particles are obtained by polymerizing a monomer composition including 1 to 10 wt % of a monocarboxylic acid monomer, and an amount of acid groups on the surface of the polymer particles as determined by a conductivity titration is 0.1 to 1.0 mmol per 1 g of the polymer particles.

### TECHNICAL FIELD

The present invention relates to a lithium ion secondary battery negative electrode slurry composition, a Lithium ion secondary battery negative electrode and a lithium ion secondary battery.

### BACKGROUND ART

In recent years, the development and commercialization of hybrid electric vehicles (HEVs), which use both an engine and a motor as power sources, have been being advanced on a global scale for the purposes of reduction in CO₂ emissions and improvement in fuel efficiency. One of the object of the HEVs is to develop of a battery which has high output, light and compact size with low cost. Currently, although a nickel-hydrogen secondary battery is used, it has problems with input-output characteristics and energy density. Therefore, since a lithium ion secondary battery having high voltage, high energy density and excellent input-output characteristics, can be reduced in size and weight, thus it is greatly expected as a power source for HEVs.

As an active material of a lithium ion secondary battery negative electrode for HEVs, a graphite carbon material is considered in the case of a design which emphasize the energy density, and an amorphous carbon material is considered in the case of a design which emphasize the input-output characteristics. Although a graphite carbon material has a high initial charge-discharge efficiency because of the small specific surface area, a capacity of 372 Ah/kg or more, which is the theoretical capacity cannot be obtained and thus a poor input-output characteristics was a problem. On the other hand, since an amorphous carbon material has a low reactivity with an electrolytic solution and dendritic metallic lithium is difficult to be generated, it has excellent input-output characteristics, and a material having a discharged capacity per unit weight of 500 Ah/kg or more can be obtained. However, since an amorphous carbon material is low in crystallinity, the electrode plate density is difficult to improve by a rolling step such as press rolling compared to that of a graphite carbon material. Thereby, since the adhesion area between active material particles is impaired, a problem that occurs is that the adhesion strength of the electrode plate decreases.

For example, Patent Literature 1 discloses that by using low crystalline carbon having a graphite interlayer distance (d002) of 0.345 to 0.370 nm as a negative electrode active material, a styrene-butadiene copolymer (SBR) as a binder and carboxymethyl cellulose as a thickening agent an excellent negative electrode can be obtained, and a battery excellent in output characteristics can be obtained.

### PATENT LITERATURE

Patent Literature 1: Japanese Patent Laid-Open No. 2009-158099

### SUMMARY OF INVENTION

### Technical Problem

However, as a result of keen examination, the present inventors have found that a battery using a negative electrode described in Patent Literature 1 has reduced output characteristics and input characteristics, among these, especially in lithium ion receiving properties was lowered at low temperatures.

Accordingly, it is an object of the present invention to provide a lithium ion secondary battery negative electrode slurry composition capable of providing a lithium ion secondary battery which has excellent lithium ion receiving properties at low temperatures, improved adhesion strength of a negative electrode plate and excellent life characteristics; a lithium ion secondary battery negative electrode; and a lithium ion secondary battery.

As a result of keen examination to solve the above problems, the present inventors have obtained the following findings. In Patent Literature 1, since polymer particles used as a binder contain polymerization units of dicarboxylic acid monomers, the hydrophilicity of the surface of the polymer particle is high. In addition, oligomers derived from dicarboxylic acid monomers are adsorbed on the surface of the polymer particles. Therefore, the surface of the hydrophobic negative electrode active material is difficult to be covered by a binder thus carboxymethyl cellulose as a thickening agent is dominantly present on the surface of the negative electrode active material. Since carboxymethyl cellulose is hardly swollen in an electrolytic solution, it interfere the movement of a lithium ion, thereby decreases the output characteristics and the input characteristics, among these, especially lithium ion receiving properties is lowered at low temperatures.

Further, in Patent Literature 1, since carboxymethyl cellulose used as a thickening agent has a small molecular weight, it is hard to say that sufficient adhesiveness of a negative electrode can be obtained, peeling of the negative electrode occurs in cycle testing of a battery and a life characteristics is deteriorated due to an increase of the internal resistance.

Therefore, as a result of keen examination, the present inventors have found that in a negative electrode slurry composition, which contains a negative electrode active material containing a carbon material having a graphite interlayer distance (an interplanar spacing (d value) of the (002) plane as determined by an X-ray diffraction method) of 0.340 to 0.370 nm, a thickening agent and a binder composed of polymer particles and water, a lithium ion secondary battery, which has excellent lithium ion receiving properties at low temperatures, improved adhesion strength of a negative electrode plate and excellent life characteristics, can be obtained by using a polymer as a thickening agent having a specific range of the degree of polymerization and polymer particles which are obtained by polymerizing a monomer composition containing a specific amount of a monocarboxylic acid monomer and in which the amount of acid groups on the surface of the polymer particles per 1 g of the polymer particles (hereinafter, it may be referred to as “the amount of surface acid groups”) as determined by conductivity titration is within a specific ratio, thereby the present invention was obtained.

### Solution to Problem

The summary of the present invention for the purpose of solving the above problem is as follows.

(1) A lithium ion secondary battery negative electrode slurry composition comprising a negative electrode active material, a thickening agent, a binder of polymer particles and water, wherein

the negative electrode active material includes a carbon material and the carbon material has a graphite interlayer distance (an interplanar spacing (d value) of the (002) plane as determined by an X-ray diffraction method) of 0.340 to 0.370 nm,
the thickening agent is a polymer having a degree of polymerization of 1400 to 3000,
the polymer particles are obtained by polymerizing a monomer composition including 1 to 10 wt % of a monocarboxylic acid monomer, and
an amount of acid groups on the surface of the polymer particles as determined by a conductivity titration is 0.1 to 1.0 mmol per 1 g of the polymer particles.

(2) The lithium ion secondary battery negative electrode slurry composition according to (1), wherein the thickening agent is an anionic cellulose polymer having a degree of etherification of 0.5 to 1.5.

(3) The lithium ion secondary battery negative electrode slurry composition according to (1) or (2), wherein the polymer particles are diene polymer or acrylic polymer.

(4) A lithium ion secondary battery negative electrode prepared by coating a lithium ion secondary battery negative electrode slurry composition according to any one of (1) to (3) onto a current collector; then by drying.

(5) A lithium ion secondary battery comprising a positive electrode, a negative electrode, a separator and an electrolytic solution, wherein the negative electrode is the lithium ion secondary battery negative electrode according to (4).

### Effects of Invention

According to the present invention, a lithium ion secondary battery negative electrode slurry composition comprises a negative electrode active material containing a carbon material having a graphite interlayer distance (an interplanar spacing (d value) of the (002) plane as determined by an X-ray diffraction method) of 0.340 to 0.370 nm, a thickening agent having a degree of polymerization of 1400 to 3000, a binder composed of polymer particles and water, wherein the binder composed of polymer particles is present near the surface of the negative electrode active material more dominantly than the thickening agent by using the polymer particles obtained by polymerizing a monomer composition containing 1 to 10 wt % of a monocarboxylic acid monomer and in which the amount of acid groups on the surface of the polymer particles as determined by conductivity titration is 0.10 to 1.0 mmol per 1 g of the polymer particles. Therefore, when a lithium ion secondary battery is produced by using the slurry composition, the lithium ion receiving properties at low temperatures (low temperature characteristics) are improved due to the fact that the polymer particles are excellent in swellability in the electrolytic solution compared with the thickening agent. In addition, since the thickening agent exists between the negative electrode active materials without being absorbed on the negative electrode active material, the adhesion strength (peeling strength) of the negative electrode is improved, thereby the life characteristics (charge-discharge cycle characteristics) of the lithium ion secondary battery is improved.

### BRIEF DESCRIPTION OF DRAWING

FIG. 1 is a graph for determining the amount of surface acid groups of polymer particles.

### DESCRIPTION OF EMBODIMENTS

### (The Lithium Ion Secondary Battery Negative Electrode Slurry Composition)

A lithium ion secondary battery negative electrode slurry composition according to the present invention comprises a negative electrode active material, a thickening agent, a binder composed of polymer particles and water.

### (The Negative Electrode Active Material)

A negative electrode active material used in the present invention contains a carbon material having a graphite interlayer distance (an interplanar spacing (d value) of the (002) plane as determined by an X-ray diffraction method) of 0.340 to 0.370 nm, preferably 0.345 to 0.370 nm. When the graphite interlayer distance of the carbon material is within the above range, a lithium ion secondary battery having excellent output characteristics can be obtained without excessively reducing the capacity per volume of the battery.

In addition, the negative electrode active material has a true density of preferably 1.4 to 2.1 g/cm³ and more preferably 1.5 to 2.0 g/cm³. When the true density of the negative electrode active material is within the above range, a lithium ion secondary battery having excellent output characteristics can be obtained without excessively reducing the capacity per volume of the battery.

The negative electrode active material in the present invention refers to as a negative electrode active material having a carbon material as a main skeleton capable of doping and dedoping lithium ions. Specifically, examples of the negative electrode active material include a carbon material and a graphite material. The carbon material generally represents a lowly graphitized (low-crystalline) carbon material produced by heat-treating (carbonization) a carbon precursor at 2000° C. or less, and the graphite material represents a graphite material having a high crystallinity close to that of graphite obtained by heat-treating graphitizable carbon at 2000° C. or more.

An example of the carbonaceous material includes graphitizable carbon in which the structure of carbon is easily changed by a heat treatment temperature, or non-graphitizable carbon having a structure close to an amorphous structure represented by glass carbon.

Examples of the graphitizable carbon include a carbon material containing tar pitch obtained from petroleum or coal as a raw material such as coke, mesocarbon microbeads (MSMB), a mesophase pitch carbon fiber and a thermal decomposition vapor grown carbon fiber or so. MCMB are carbon fine particles obtained by separating and extracting mesophase spherules generated during the process of heating the pitches at approximately 400° C. and the mesophase pitch carbon fiber is a carbon fiber containing a mesophase pitch obtained by growing and incorporating the mesophase spherules as a raw material.

Examples of the non-graphitizable carbon include a phenol resin sintered product, a polyacrylonitrile carbon fiber, quasi-isotropic carbon and a furfuryl alcohol resin sintered product (PFA) or so.

The negative electrode active material used in the present invention has a specific surface area in the range of preferably 0.1 to 20 m²/g and more preferably 0.5 to 10 m²/g. When the specific surface area of the negative electrode active material is within the above range, the amount of a binder can be decreased when a slurry composition described later is prepared, thereby the battery capacity decline can be easily suppressed, and the slurry composition described later can be easily adjusted to an adequate viscosity to apply.

The negative electrode active material used in the present invention has a particle diameter of usually 1 to 50 μm and more preferably 2 to 30 μm. When the particle diameter of the negative electrode active material is within the above range, the amount of a binder can be decreased when a slurry composition described later is prepared, thereby the battery capacity decline can be easily suppressed, and the slurry composition can be adjusted to an adequate viscosity to apply.

In addition, in the present invention, a negative electrode active material containing a carbon material having a graphite interlayer distance (an interplanar spacing (d value) of the (002) plane as determined by an X-ray diffraction method) of less than 0.340 nm may be mixed, as long as the effects of the present invention are not impaired. When a negative electrode active material having a graphite interlayer distance of less than 0.34 nm is mixed and used, the weight ratio between a negative electrode active material having a graphite interlayer distance of 0.340 to 0.370 nm and a negative electrode active material having a graphite interlayer distance of less than 0.340 nm is preferably 99:1 to 60:40 and preferably 90:10 to 70:30.

### (The Thickening Agent)

The thickening agent in the present invention is a polymer which can impart a high viscosity to a slurry composition just by adding a small amount and has properties of improving the coatability of the slurry composition. The thickening agent used in the present invention has a degree of polymerization of 1400 to 3000, preferably 1450 to 2500 and more preferably 1500 to 2000. When the degree of polymerization of the thickening agent is within the above range, the thickening agent exists between the negative electrode active materials without absorbing on the surface of the negative electrode active material, thereby improving the adhesion strength inside the negative electrode active material layer. When the degree of polymerization of the thickening agent is less than the above range, the surface of the negative electrode active material is easily coated with the thickening agent and the adhesion strength inside the negative electrode active material layer is deceased. On the contrary, when the degree of polymerization of the thickening agent exceeds the above range, the difference between the viscosity of the slurry composition in a stationary state and the viscosity in a fluidized state becomes large, thereby causing a problem of uneven thickness when coating the slurry composition.

The degree of polymerization of the thickening agent is measured by a copper/ammonia method prescribed in ISO-4312 Method.

Examples of the thickening agent used in the present invention include those obtained by modifying polysaccharides derived from a vegetable or an animal and a natural polymer such as a protein by means of a chemical reaction. Specific examples of the thickening agent include a starch polymer, a cellulose polymer, an alginic acid polymer and a microbial polymer or so. In addition, as the thickening agent, a polyacrylic acid and a salt thereof and the like can also be used.

Examples of the starch polymer include a solubilized starch, a carboxymethyl starch or so, a methylhydroxypropyl starch and a modified potato starch.

A cellulose polymer can be classified into nonionic, cationic and anionic.

Examples of the nonionic cellulose polymer include: an alkyl cellulose such as methylcellulose, methyl ethyl cellulose, ethyl cellulose and microcrystalline cellulose or so; and a hydroxyalkyl cellulose such as hydroxyethyl cellulose, hydroxybutyl methyl cellulose, hydroxypropyl cellulose, hydroxypropyl methyl cellulose, hydroxyethyl methyl cellulose, hydroxypropylmethyl cellulose stearoxy ether, carboxymethyl hydroxyethyl cellulose, alkylhydroxyethyl cellulose and nonoxynyl hydroxyethyl cellulose or so.

Examples of the cationic cellulose polymer include low nitrogen hydroxyethylcellulose dimethyldiallylammonium chloride (polyquaternium-4), [2-hydroxy-3-(trimethylammonio)propyl]hydroxyethyl cellulose chloride (polyquaternium-10) and [2-hyrdoxy-3-(lauryldimethylammonio)propyl]hydroxyethylcellulose chloride (polyquaternium-24) or so.

Examples of the anionic cellulose polymer include an alkyl cellulose ether having structures of general formulas (1) and (2) in which the above nonionic cellulose polymers are substituted with various derivative groups and metal salts or ammonium salts thereof. Specific examples of anionic cellulose polymer include cellulose sodium sulfate, methylcellulose ether, methylethylcellulose ether, ethylcellulose ether, carboxymethylcellulose ether (CMC) and a salt thereof or so.

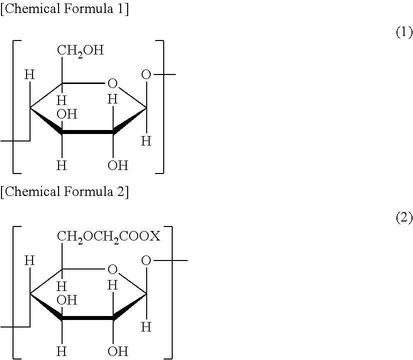

Examples of the alginic acid polymer include sodium alginate and propyleneglycol alginate or so. Examples of the chemically modified microbial polymer include xanthane gum, dehydroxanthane gum, dextran, succinoglucan and pullulan or so.

Among these, since a slurry composition having excellent dispersibility can be made when used with the negative electrode active material, and the surface smoothness of the negative electrode obtained by using the slurry composition can be enhanced, a cellulose polymer is preferred. In addition, an anionic cellulose polymer is preferred because it shows high adhesion when preparing the negative electrode. Among others, carboxymethyl cellulose is most preferred because bubbling and the like are little when preparing an aqueous solution, and a smooth electrode can be obtained.

In the present invention, the anionic cellulose polymer, which is suitable as a thickening agent, has a degree of etherification of preferably 0.5 to 1.5 and more preferably 0.6 to 1.0. When the degree of etherification of the anionic cellulose polymer is within the above range, the affinity with the negative electrode active material is reduced and the thickening agent is prevented from being localized on the negative electrode active material surface, as well as the adhesion between the active material layer and the current collector in the electrode can be maintained and the adhesion of the negative electrode plate is significantly improved, which is one of the effects of the present invention. The degree of etherification means a degree of substitution of a carboxymethyl group and the like with hydroxyl groups (three) per one anhydroglucose unit in the cellulose. Theoretically, the degree of etherification can be a value from 0 to 3. This shows that as the degree of etherification is higher, the ratio of the hydroxyl group in the cellulose is decreased and the ratio of the substituent is increased; and as the degree of etherification is lower, the ratio of the hydroxyl group in the cellulose is increased and the ratio of the substituent is decreased. The degree of etherification (substitution degree) is determined by the following method and expression.

Firstly, 0.5 to 0.7 g of a sample is accurately weighed and carbonized in a magnetic crucible. After cooling, the obtained carbonized product is transferred to a 500 ml beaker, followed by adding approximately 250 ml of water and 35 ml of an N/10 aqueous solution of sulfuric acid with a pipette to boil for 30 minutes. After cooling the resulting solution, the phenolphthalein reagent is added and the excessive acid is back titrated with an N/10 aqueous solution of potassium hydroxide and the substitution degree is calculated from the following expressions (I) and (II).

[Expression 1]

A=(a×f−b×f¹)/sample(g)−alkaline degree(or +acid degree). (I)

[Expression 2]

The degree of substitution=M×A/(10000−80A) (II)

In the above expressions (I) and (II), A is an amount (ml) of an N/10 aqueous solution of sulfuric acid consumed by the bonded alkali metal ions in 1 g of a sample. a is an amount of an N/10 aqueous solution of sulfuric acid used (ml). f is a titer coefficient of an N/10 aqueous solution of sulfuric acid. b is a titration amount (ml) of an N/10 aqueous solution of potassium hydroxide. f¹ is a titer coefficient of an N/10 aqueous solution of potassium hydroxide. M is weight average molecular weight of a sample.

In addition, among the anionic cellulose polymers, an alkylcellulose ether and a metal salt or an ammonium salt thereof is preferable, that is, those in which X is an alkali metal, NH₄ and H is preferable, and those in which X is Li, Na, NH₄ and H, in the above general formula (2) is more preferable. By using the above X, the dispersion stability of polymer particles in a slurry composition can be maintained and the nonuniformity of the application amount for the electrode plate due to the increase in viscosity of the slurry composition can be prevented. Further, the alkylcellulose ether may have a plurality of structures which are different in X.

### (The Binder)

A binder used in the present invention is composed of polymer particles.

The polymer particles are obtained by polymerizing a monomer composition containing 1 to 10 wt % of a monocarboxylic acid monomer. The content of the monocarboxylic acid monomer in the monomer composition is preferably 1.5 to 8 wt % and more preferably 2 to 5 wt %. In addition, the amount of acid groups on the surface of the polymer particles per 1 g of polymer particles as measured by conductivity titration is 0.10 to 1.0 mmol, preferably 0.15 to 0.75 mmol and more preferably 0.20 to 0.50 mmol.

When the content of the monocarboxylic acid monomer in the monomer composition and the amount of acid groups on the surface of polymer particles per 1 g of polymer particles as measured by conductivity titration are within the above range, the polymer particles can be selectively exist on the surface of the negative electrode active material, and lithium ion receiving properties at low temperature can be improved. In addition, since the adhesion of the negative electrode active materials against each other and the adhesion between the negative electrode active material and the current collector can be improved, the adhesion strength of the negative electrode improves.

When the content of the monocarboxylic acid monomer in the monomer composition is less than 1 wt %, a sufficient adhesion between the negative electrode active material and the current collector can not be obtained and the adhesion strength of the negative electrode decreases. When the content of the monocarboxylic acid monomer in the monomer composition exceeds 10 wt %, since the hydrophilicity of the polymer particles becomes high and the polymer particles cannot be selectively exist on the surface of the hydrophobic negative electrode active material, thus the above effects cannot be obtained. In addition, when the amount of surface acid groups of polymer particles per g of polymer particles as measured by the conductivity titration is less than 0.10 mmol, since the blending stability of a binder significantly declines when preparing a slurry composition and the viscosity of the slurry composition increases, thus the above effects cannot be obtained. On the contrary, when the amount of the surface acid groups of the polymer particles per 1 g of polymer particles as measured by the conductivity titration exceeds 1.0 mmol, since the hydrophilicity of the polymer particles increases and the polymer particles cannot selectively exist on the surface of the hydrophobic negative electrode active material, thus the above effects cannot be obtained.

The monocarboxylic acid monomer is preferably an ethylenically unsaturated monocarboxylic acid monomer. Examples of the ethylenically unsaturated monocarboxylic acid monomer include acrylic acid, methacrylic acid, crotonic acid, isocrotonic acid, angelic acid, tiglic acid, or partially esterified compounds of ethylenically unsaturated polyvalent carboxylic acids such as monobutyl fumarate, monoethyl maleate and monomethyl itacoate. Among these, methacrylic acid, crotonic acid, isocrotonic acid, angelic acid and tiglic acid are preferable from the point of the high hydrophobicity and the high affinity with the negative electrode active material. Note that, the monomer composition may contain a dicarboxylic acid monomer as long as the above effects are not impaired.

As a means for having a functional group derived from an acid component on the polymer particles surface, it is preferable to use a hydrophobic functional group at the α-position or β-position of the carboxyl group, for example, an ethylenically unsaturated monocarboxylic acid monomer having an alkyl side chain or so. Specifically, methacrylic acid is especially preferably used.

The binder is a dispersion liquid in which the polymer particles having binding properties are dispersed in water (hereinafter, there may be collectively referred to as a “polymer particle dispersion liquid”). Examples of the polymer particle dispersion liquid include a diene polymer particle dispersion liquid, an acrylic polymer particle dispersion liquid, a fluorine polymer particle dispersion liquid and a silicon polymer particle dispersion liquid or so. Among these, a diene polymer particle dispersion liquid and an acrylic polymer particle dispersion liquid are preferable because these have excellent binding properties with the negative electrode active material and the obtained negative electrode has excellent strength and flexibility. When a diene polymer particle dispersion liquid or an acrylic polymer particle dispersion liquid is used, peeling of the negative electrode or the like hardly occurs due to the high binding properties with the negative electrode active material. As a result, since peeling of the binder hardly occurs against swelling/shrinking of the negative electrode active material during charging and discharging, the negative electrode active material is prevented from being peeled off from the current collector and the resistance increase of the negative electrode is prevented, thereby the high charge and discharge cycle characteristics can be exhibited.

The diene polymer particle dispersion liquid is a water dispersion liquid of a polymer (diene polymer) containing monomer units obtained by polymerizing a conjugated diene such as butadiene and isoprene or so. The ratio of the monomer units obtained by polymerizing the conjugated diene in the diene polymer is usually 30 wt % or more, preferably 40 wt % or more and more preferably 50 wt % or more. Examples of the diene polymer include a copolymer of a conjugated diene, an ethylenically unsaturated monocarboxylic acid monomer and a copolymerizable monomer. Examples of the copolymerizable monomer include: an α, β-unsaturated nitrile compound such as acrylonitrile and methacrylonitrile; a styrene monomer such as styrene, chlorostyrene, vinyl toluene, t-butylstyrene, vinyl benzoic acid, methyl vinyl benzoate, vinylnaphthalene, chloromethylstyrene, hydroxymethylstyrene, α-methylstyrene and divinylbenzene or so; olefins such as ethylene and propylene or so; a halogen atom-containing monomer such as vinyl chloride and vinylidene chloride or so; vinyl esters such as vinyl acetate, vinyl propionate, vinyl butyrate and vinyl benzoate or so; vinyl ethers such as methyl vinyl ether, ethyl vinyl ether and butyl vinyl ether or so; vinyl ketones such as methyl vinyl ketone, ethyl vinyl ketone, butyl vinyl ketone, hexyl vinyl ketone and isopropenyl vinyl ketone or so; and a heterocycle-containing vinyl compound such as N-vinylpyrrolidone, vinylpyridine and vinylimidazole or so. Among these, α, β-unsaturated nitrile compound or a styrene monomer is preferable and a styrene monomer is especially preferable. The ratio of these copolymerizable monomer units is preferably 5 to 70 wt % and more preferably 10 to 60 wt %.

The acrylic polymer particle dispersion liquid is a water dispersion liquid of a polymer (acrylic polymer) containing monomer units obtained by polymerizing an acrylic acid ester and/or a methacrylic acid ester. The ratio of the monomer units obtained by polymerizing the acrylic acid ester and/or the methacrylic acid ester in the acrylic polymer is usually 40 wt % or more, preferably wt % or more and more preferably 60 wt % or more. Examples of the acrylic polymer include a copolymer of a copolymerizable monomer, and an acrylic acid ester and/or a methacrylic acid ester and an ethylenically unsaturated monocarboxylic acid monomer.

Examples of the acrylic acid ester and/or the methacrylic acid ester include: an acrylic acid alkyl ester such as methyl acrylate, ethyl acrylate, n-propyl acrylate, isopropyl acrylate, n-butyl acrylate, t-butyl acrylate, pentyl acrylate, hexyl acrylate, heptyl acrylate, octyl acrylate, 2-ethylhexyl acrylate, nonyl acrylate, decyl acrylate, lauryl acrylate, n-tetradecyl acrylate and stearyl acrylate or so; and a methacrylic acid alkyl ester such as methyl methacrylate, ethyl methacrylate, n-propyl methacrylate, isopropyl methacrylate, n-butyl methacrylate, t-butyl methacrylate, pentyl methacrylate, hexyl methacrylate, heptyl methacrylate, octyl methacrylate, 2-ethylhexyl methacrylate, nonyl methacrylate, decyl methacrylate, lauryl methacrylate, n-tetradecyl methacrylate and stearyl methacrylate or so.

Examples of the copolymerizable monomer include: a carboxylic acid ester monomer having two or more carbon-carbon double bonds such as ethylene glycol dimethacrylate, diethylene glycol dimethacrylate and trimethylolpropane triacrylate or so; a styrene monomer such as styrene, chlorostyrene, vinyl toluene, t-butyl styrene, vinyl benzoic acid, vinyl methyl benzoate, vinylnaphthalene, chloromethylstyrene, hydroxymethylstyrene, α-methylstyrene and divinylbenzene or so; an amide monomer such as acrylamide, N-methylol acrylamide and acrylamide-2-methylpropanesulfonic acid or so; an α,β-unsaturated nitrile compound such as acrylonitrile and methacrylonitrile or so; olefins such as ethylene and propylene; a halogen atom-containing monomer such as vinyl chloride and vinylidene chlorid or soe; vinyl esters such as vinyl acetate, vinyl propionate, vinyl butyrate and vinyl benzoate or so; vinyl ethers such as methyl vinyl ether, ethyl vinyl ether and butyl vinyl ether or so; vinyl ketones such as methyl vinyl ketone, ethyl vinyl ketone, butyl vinyl ketone, hexyl vinyl ketone and isopropenyl vinyl ketone or so; and a heterocycle-containing vinyl compound such as N-vinyl pyrrolidone, vinylpyridine and vinylimidazole or so. Among these, an α,β-unsaturated nitrile compound or a styrene monomer is preferable and an α,β-unsaturated nitrile compound is especially preferable. The ratio of the structural unit derived from these copolymerizable monomers is preferably 3 to 50 wt % s and more preferably 5 to 40 wt %.

The polymer particle dispersion liquid can be produced, for example, by emulsion-polymerizing a monomer composition containing the above polymer in the water. A number average particle diameter of the polymer particles in the polymer particle dispersion liquid is preferably 50 to 500 nm and more preferably 70 to 400 nm. When the number average particle diameter of the polymer particles is within the above range, the obtained negative electrode has excellent strength and flexibility.

The binder has a glass transition temperature of preferably 25° C. or less, more preferably from −100 to +25° C., further more preferably from −80 to +10° C. and most preferably from −80 to 0° C. When the glass transition temperature of the binder is within the above range, the characteristics such as the flexibility, binding properties and windability of the negative electrode and the adhesion between the negative electrode active material and the current collector are suitably highly balanced.

In addition, the binder may be a binder composed of polymer particles having a core shell structure obtained by stepwise polymerizing two or more monomer compositions. When polymer particles having a core shell structure are used, the core portion is not particularly limited, but the monomer composition constituting the shell portion contains 1 to 5 wt % of a monocarboxylic acid monomer, and the amount of surface acid groups of the polymer particles per 1 g of the polymer particles as measured by conductivity titration is preferably 0.10 to 0.50 mmol.

In the lithium ion secondary battery negative electrode slurry composition of the present invention, the total content of the negative electrode active material and the binder is preferably 10 to 90 parts by weight and more preferably 30 to 80 parts by weight, with respect to 100 parts by weight of the slurry composition. In addition, the content (in terms of solid portion equivalent) of the binder relative to the total amount of the negative electrode active material is preferably 0.1 to 5 parts by weight and more preferably 0.5 to 2 parts by weight, with respect to the total amount of 100 parts by weight of the negative electrode active material. When the total content of the negative electrode active material and the binder and the content of the binder are within the above range in the slurry composition, the viscosity of the obtained lithium ion secondary battery negative electrode slurry composition is adjusted appropriately and the coating can be carried out smoothly. In addition, the resistance of the resulting negative electrode does not increase and a sufficient adhesion strength is achieved, thereby the binder is prevented from being peeled off from the negative electrode active material in the electrode plate pressing step.

### (The Dispersion Medium)

In the present invention, water is used as a dispersion medium. In the present invention, a mixture prepared by mixing a hydrophilic solvent with water may be used as a dispersion medium as long as the dispersion stability of a binder is not impaired. As the hydrophilic solvent by methanol, ethanol, N-methylpyrrolidone and the like may be mentioned, and the content is preferably 5 wt % or less with respect to water.

### (The Conductive Agent)

A conductive agent is preferably comprised in the lithium ion secondary battery negative electrode slurry composition of the present invention. As the conductive agent, a conductive carbon such as acetylene black, ketjen black, carbon black, graphite, a vapor-phase grown carbon fiber, a carbon nanotube and the like can be used. In order to improve the electrical contact between the negative electrode active materials by including the conductive agent, and when the conductive agent is used in a lithium ion secondary battery, the discharge rate characteristics can be improved. The content of the conductive agent in the slurry composition is preferably 1 to 20 parts by weight and more preferably 1 to 10 parts by weight, with respect to the total amount of 100 parts by weight of the negative electrode active material.

The lithium ion secondary battery negative electrode slurry composition may further include, in addition to the above components, other components such as a reinforcement material, a leveling agent and an electrolyte additive having the electrolytic solution degradation suppression function, which may be included in a secondary battery negative electrode described in the following. These are not particularly limited as long as the battery reaction is not influenced.

As the reinforcement material, various inorganic and organic fillers having a spherical shape, plate shape, rod shape, fibrous shape can be used. A tough and flexible negative electrode can be obtained by using a reinforcement material, and an excellent long-term cycle characteristics can be exhibited. The content of the reinforcement material in the slurry composition is usually 0.01 to 20 parts by weight and preferably 1 to 10 parts by weight with respect to the total amount of 100 parts by weight of the negative electrode active material. If the content of the reinforcement material are within the above range, high capacity and high load characteristics can be exhibited.

Examples of the leveling agent include a surfactant such as an alkyl surfactant, a silicon surfactant, a fluorine surfactant and a metal surfactant. The repelling which occurs during coating can be prevented and the smoothness of the negative electrode can be improved by adding the leveling agent. The content of the leveling agent in the slurry composition is preferably 0.01 to 10 parts by weight, with respect to the total amount of 100 parts by weight of the negative electrode active material. When the content of the leveling agent is within the above range, the negative electrode has excellent in productivity, smoothness and battery characteristics during preparing the negative electrode. The dispersibility of the negative electrode active material and the like in the slurry composition can be improved by including a surfactant and further the smoothness of the resulting negative electrode can be improved.

As the electrolytic solution additive, a vinylene carbonate and the like, which are used in the slurry composition or the electrolytic solution can be use. The content of the electrolytic solution additive in the slurry composition is preferably 0.01 to 10 parts by weight, with respect to the total amount of 100 parts by weight of the negative electrode active material. When the content of the e electrolytic solution additive is within the above range, the cycle characteristics and high-temperature characteristics are good. In addition to the above, as the additive, nanoparticles such as fumed silica or fumed aluminum or so may be mentioned. The thixotropic properties of the slurry composition can be controlled by adding nanoparticles, and further the leveling properties of the resulting negative electrode can be improved. The content of the nanoparticles in the slurry composition is preferably 0.01 to 10 parts by weight, with respect to the total amount of 100 parts by weight of the negative electrode active material. When the content of the nanoparticles is within the above range, the electrode has excellent slurry stability and productivity, and exhibits high battery characteristics.

### (The Method for Producing Lithium Ion Secondary Battery Negative Electrode Slurry Composition)

The lithium ion secondary battery negative electrode slurry composition is obtained by mixing in water the negative electrode active material described above, a thickening agent, a binder composed of polymer particles, a conductive agent and the like used as needed.

The mixing method is not particularly limited, but a method of using a stirring-type, a shaking-type or a rotating-type mixing device may be mentioned. In addition, other examples of the mixing method include a method of using a dispersion kneading machine such as a homogenizer, a ball mill, a sand mill, a roll mill and a planetary kneader or so.

### (The Lithium Ion Secondary Battery Negative Electrode)

The lithium ion secondary battery negative electrode of the present invention is produced by applying a lithium ion secondary battery negative electrode slurry composition according to the present invention onto a current collector and then by drying.

### (The Method for Producing Lithium Ion Secondary Battery Negative Electrode)

A method for producing the lithium ion secondary battery negative electrode is not particularly limited, but a method of applying the slurry composition onto at least one surface, preferably both surfaces of a current collector to form a negative electrode active material layer may be mentioned.

The method for applying a slurry composition onto a current collector is not particularly limited. However, a method such as a doctor blade method, a dip method, a reverse roll method, a direct roll method, a gravure method, an extrusion method and a brush coating method or so may be mentioned.

Examples of the drying method include drying with warm wind, hot wind or low humidity wind, vacuum drying, drying by radiation with (far-) infrared ray or electron beam or so. The drying time is usually 5 to 30 minutes and the drying temperature is usually 40 to 180° C.

When producing the lithium ion secondary battery negative electrode of the present invention, it is preferable to employ a method in which after applying the slurry composition onto a current collector and drying, the porosity of the negative electrode active material layer is decreased by pressure treatment using a mold press or a roll press. The range of the porosity is preferably 5 to 30% and more preferably 7 to 20%. When the porosity is too high, the charge efficiency and discharge efficiency are deteriorated. When the porosity is too low, it is difficult to obtain high volume capacity, and the negative electrode active material layer tends to be peeled off from the current collector which easily causes defectives. Further, when a curable polymer is used as a binder, the polymer is preferably cured.

The thickness of the negative electrode active material layer in the lithium ion secondary battery negative electrode of the present invention is usually 5 to 300 μm and preferably 30 to 250 μm. When the thickness of the negative electrode active material layer is within the above range, both high load characteristics and cycle characteristics are exhibited.

In the present invention, the content ratio of the negative electrode active material in the negative electrode active material layer is preferably 85 to 99 wt % and more preferably 88 to 97 wt %. When the content ratio of the negative electrode active material is adjusted within the above range, the high capacity can be exhibited while the flexibility and binding properties can be exhibited as well.

In the present invention, the density of the negative electrode active material layer of the lithium ion secondary battery negative electrode is preferably 1.6 to 1.9 g/cm³ and more preferably 1.65 to 1.85 g/cm³. When the density of the negative electrode active material layer is within the above range, a high capacity battery can be obtained.

### (The Current Collector)

The current collector used in the present invention is not particularly limited, as long as it is an electrically conductive and electrochemically resistant material, and a metallic material having heat resistance is preferable. Examples of the metallic material include iron, copper, aluminum, nickel, stainless steel, titanium, tantalum, gold and platinum or so. Among these, copper is especially preferable as a current collector used for a lithium ion secondary battery negative electrode. The shape of the current collector is not particularly limited, however a sheet-like current collector having a thickness of approximately 0.001 to 0.5 mm is preferable. The current collector is preferably used by carrying out the surface roughening treatment in advance in order to improve the adhesive strength with the negative electrode active material layer. The method for surface roughening includes a mechanical polishing method, an electropolishing method, a chemical polishing method and the like. In the mechanical polishing method, an abrasive cloth paper on which abrasive particles are attached, grinding stone, an emery buff, a wire brush equipped with steel wires and the like can be used. In addition, in order to increase the adhesive strength and conductivity of a mixture, an interlayer may be formed on the surface of the current collector.

### (The Lithium Ion Secondary Battery)

The lithium ion secondary battery of the present invention comprises a positive electrode, a negative electrode, a separator and an electrolytic solution wherein the negative electrode is the above lithium ion secondary battery negative electrode.

### (The Positive Electrode)

The positive electrode formed stacking a positive electrode active material layer containing a positive electrode active material and a positive electrode binder on a current collector.

### (The Positive Electrode Active Material)

As the positive electrode active materials, an active material capable of doping and dedoping lithium ions is used, and is by in large separated into ones formed by an inorganic compound and ones formed by an organic compound.

Examples of the positive electrode active material formed of an inorganic compound include a transition metal oxide, a transition metal sulfide, and a lithium-containing composite metal oxide of lithium and a transition metal. As the transition metal, Ti, V, Cr, Mn, Fe, Co, Ni, Cu, Mo and the like are used.

Examples of the transition metal oxide include MnO, MnO₂, V₂O₅, V₆O₁₃, TiO₂, Cu₂V₂O₃, amorphous V₂O—P₂O₅, MoO₃, V₂O₅ and V₆O₁₃ or so. Among these, MnO, V₂O₅, V₆O₁₃ and TiO₂ are preferable from the point of the cycle stability and capacity. Examples of the transition metal sulfide include TiS₂, TiS₃, amorphous MoS₂ and FeS or so. Examples of the lithium-containing composite metal oxide include a lithium-containing composite metal oxide having a layer structure, a lithium-containing composite metal oxide having a spinel structure and a lithium-containing composite metal oxide having an olivine type structure or so.

Examples of the lithium-containing composite metal oxide having a layer structure include a lithium-containing cobalt oxide (LiCoO₂), a lithium-containing nickel oxide (LiNiO₂), a lithium composite oxide of Co—Ni—Mn, a lithium composite oxide of Ni—Mn—Al and a lithium composite oxide of Ni—Co—Al or so. Examples of the lithium-containing composite metal oxide having a spinel structure include lithium manganate (LiMn₂O₄) and Li[Mn_{3/2}M_{1/2}]O₄ (wherein, M is Cr, Fe, Co, Ni, Cu and the like) in which a part of Mn is substituted with other transition metals. An example of the lithium-containing composite metal oxide having an olivine type structure includes an olivine-type lithium phosphate compound represented by LiₓMPO₄ (wherein, M is at least one selected from Mn, Fe, Co, Ni, Cu, Mg, Zn, V, Ca, Sr, Ba, Ti, Al, Si, B and Mo, and O≦X≦2).

As the organic compound, a conductive polymer such as polyacetylene, poly-p-phenylene or so can be used. An iron oxide having poor electrical conductivity may be used as an electrode active material covered with a carbon material by allowing a carbon source material to exist during reduction firing. In addition, the elements of these compounds may be partially substituted. The positive electrode active material for a lithium ion secondary battery may be a mixture of the above inorganic compound and organic compound.

The positive electrode active material has an average particle diameter of usually 1 to 50 μm and preferably 2 to 30 μm. When the particle diameter is within the above range, the amount of a binder for the positive electrode in preparing the positive electrode slurry composition described later can be reduced, the decrease in capacity of a battery can be suppressed and the positive electrode slurry composition can easily be adjusted to an appropriate viscosity for coating, thereby an uniform electrode can be obtained.

The content ratio of the positive electrode active material in the positive electrode active material layer is preferably 90 to 99.9 wt % and more preferably 95 to 99 wt %. When the content of the positive electrode active material in the positive electrode is within the above range, the positive electrode exhibits high capacity while exhibiting flexibility and binding properties.

### (The Binder for Positive Electrode)

The binder for the positive electrode is not particularly limited and a known one can be used. For example, a resin such as polyethylene, polytetrafluoroethylene (PTFE), polyvinylidene fluoride (PVDF), a tetrafluoroethylene-hexafluoropropylene copolymer (FEP), a polyacrylic acid derivative and a polyacrylonitrile derivative, and a soft polymer such as an acrylic soft polymer, a diene soft polymer, an olefin soft polymer and a vinyl soft polymer, which are used for the above negative electrode of a lithium ion secondary battery can be used. These may be used alone or by combining two or more thereof.

The positive electrode may further contain, in addition to the above components, other components such as the electrolytic solution additives having the above electrolytic solution degradation suppression function and the like. These are not particularly limited as long as it does not affect the battery reaction.

As the current collector, a current collector which is used for the above lithium ion secondary battery negative electrode can be used. The current collector is not particularly limited as long as it is an electrically conductive and electrochemically resistant material, and aluminum is especially preferable as the positive electrode of a lithium ion secondary battery.

The positive electrode active material layer has a thickness of usually 5 to 300 μm and preferably 10 to 250 μm. When the thickness of the positive electrode active material layer is within the above range, both high load characteristics and energy density are exhibited.

The positive electrode can be produced as same as the lithium ion secondary battery negative electrode.

### (Separator)

A separator is a porous substrate having pores, and examples of the separator that can be used include (a) a porous separator having pores, (b) a porous separator which a polymer coat layer is formed on one or both surfaces, or (c) a porous separator which a porous resin coat layer containing inorganic ceramic powder is formed on the surface. The non-limiting examples of these separators include: a polypropylene, polyethylene, polyolefinor aramid porous separator; a separator coated with a polymer film or a gelling polymer coating layer for a solid polyelectrolyte or a gelatinous polyelectrolyte such as polyvinylidene fluoride, polyethylene oxide, polyacrylonitrile and a polyvinylidene fluoride hexafluoropropylene copolymer; and a separator coated with a porous film layer composed of a dispersant for an inorganic filler or an inorganic filler.

### (The Electrolytic Solution)

The electrolytic solution used in the present invention is not particularly limited, but for example, those in which a lithium salt dissolved as a supporting electrolyte in a nonaqueous solvent can be used. Examples of the lithium salt include a lithium salt such as LiPF₆, LiAsF₆, LiBF₄, LiSbF₆, LiAlCl₄, LiClO₄, CF₃SO₃L₁, C₄F₉SO₃L₁, CF₃COOLi, (CF₃CO)₂Nli, (CF₃SO₂)₂Nli and (C₂F₅SO₂)NLi or so. Especially preferably used are LiPF₅, LiClO₄ and CF₃SO₃Li, which can easily dissolve a solvent and exhibit a high dissociation degree. These can be used alone or by combining two or more thereof. The amount of the supporting electrolyte is usually 1 wt % or more, preferably 5 wt % or more, and usually 30 wt % or less and preferably 20 wt % or less, with respect to the electrolytic solution. When the amount of the supporting electrolyte is too small or too large, the ion conductivity declines and the charge and discharge characteristics of the battery decline.

A solvent used in the electrolytic solution is not particularly limited as long as it dissolves the supporting electrolyte, however alkyl carbonates such as dimethyl carbonate (DMC), ethylene carbonate (EC), diethyl carbonate (DEC), propylene carbonate (PC), butylene carbonate (BC) and methyl ethyl carbonate (MEC) or so; esters such as γ-butyrolactone and methyl formate or so; ethers such as 1,2-dimethoxyethane and tetrahydrofuran or so; and sulfur-containing compounds such as sulfolane and dimethylsulfoxide or so may be mentioned. Dimethyl carbonate, ethylene carbonate, propylene carbonate, diethyl carbonate and methyl ethyl carbonate are preferable because especially high ionic conductivity is easily obtained and the operating temperature range is wide. These can be used lone or by combining two or more thereof. In addition, an additive can also be used by adding into the electrolytic solution. As the additive, a carbonate compound such as vinylene carbonate (VC) or so is preferable.

Examples of the electrolytic solution other than the above include a gelatinous polymer electrolyte in which an electrolytic solution is immersed with a polymer electrolyte such as polyethylene oxide and polyacrylonitrile, and an inorganic solid electrolyte such as lithium sulfide, LiI and Li₃N or so.

### (The Method for Production of Lithium Ion Secondary Battery)

The method for producing a lithium ion secondary battery of the present invention is not particularly limited. For example, the above negative and positive electrodes are stacked against each other via a separator and wound or folded according to the battery shape to place into a battery container and the battery container is sealed after an electrolytic solution is poured into the battery container. Further, an expanded metal, an overcurrent preventing element such as a fuse or a PTC element and a lead plate may be placed depending on the needs thereby the pressure increase inside the battery and overcharge and overdischarge can also be prevented. The shape of the battery may be a stacking cell type, a coin type, a button type, a sheet type, a cylindrical type, a square type, a flat type or the like.

### EXAMPLES

The present invention will be described by referring to the examples, however the present invention is not limited thereto. Further, the “parts” and “%” in the present examples are based on the weight basis unless otherwise specified. In Examples and Comparative Examples, various physical properties were evaluated as follows.

### (The Peeling Strength)

The negative electrodes are cut into rectangular shapes with a width of 1 cm and a length of 10 cm respectively, which are used as test pieces, and the negative electrode active material layer surface is fixed so as to face upward. After a scotch tape is stuck to the surface of the negative electrode active material layer of the test piece, the stress is measured when the scotch tape is peeled off from one end of the test piece in the 180 degree direction at a rate of 50 mm/min. The measurement was performed 10 for times and the average value of 10 measurements was determined and defined as peeling strength. Evaluation was carried out based on the following standards. The larger this values is, the larger the adhesive strength of the negative electrode is.

A: 6 N/m or more
B: 5 N/m or more to less than 6 N/m
C: 4 N/m or more to less than 5 N/m
D: 3 N/m or more to less than 4 N/m
E: 2 N/m or more to less than 3 N/m
F: Less than 2 N/m

### (The Charge and Discharge Characteristics)

### (1) Low-Temperature Characteristics (0° C.)

By using the obtained half-cells, the charge and discharge rate at 25° C. is set at 0.1 C and the half-cells are charged with a constant current until 0.02 V by a constant-current constant-voltage charging method and then charged by a constant voltage. After charging, the charge and discharge in which discharging is performed until 1.5 V were carried out for two cycles, then the constant-current constant-voltage charge was carried out at 0.1 C in a constant-temperature bath at 0° C. The battery capacity obtained during the constant current in the constant-current constant-voltage charge is defined as an index of lithium ion receiving properties, and evaluated based on the following criteria. The larger the value is, the better the battery is in low-temperature characteristics and has better satisfactory lithium ion receiving properties.

A: 200 mAh/g or more
B: 180 mAh/g or more to less than 200 mAh/g
C: 160 mAh/g or more to less than 180 mAh/g
D: 140 mAh/g or more to less than 160 mAh/g
E: Less than 140 mAh/g

### (2) Charge and Discharge Cycle Characteristics

The resulting half-cells are charged with a constant current until 0.02 V by a 0.1 C constant-current constant-voltage charging method at 25° C. respectively and then charged with a constant voltage, and further a charge and discharge cycle was carried out in which discharging with a 0.1 C constant current until 1.5 V. The charge and discharge cycle is carried out for 50 cycles and the ratio of the discharge capacity at 50th cycle against the initial discharge capacity is defined as a capacity maintenance rate. Evaluation is made based on the following criteria. The larger the value is, the smaller the capacity reduction due to the repeated charge and discharge is, that is, the battery is better in charge and discharge cycle characteristics.

A: 80% or more
B: 70% or more to less than 80%
C: 60% or more to less than 70%
D: 50% or more to less than 60%
E: 40% or more to less than 50%
F: Less than 40%

In addition, the degree of polymerization of a thickening agent and the amount of surface acid groups of polymer particles are measured as follows.

### (The Degree of Polymerization of Thickening Agent)

The degree of polymerization of a thickening agent is measured by a copper/ammonia method described in ISO-4312 Method.

### (The Amount of Surface Acid Groups of Polymer Particles)

Into a 150 ml glass container washed with distilled water, 50 g of a polymer particle dispersion liquid in which the solid portion concentration is adjusted to 2% is added. The glass container is set to a solution electric conductivity meter (CM-117, manufactured by Kyoto Electronics Manufacturing Co., Ltd., type of cell: K-121), and the polymer particle dispersion liquid is stirred. The stirring is continued until the addition of hydrochloric acid is completed. After 6 minutes from the addition of 0.1 N of sodium hydroxide (special grade reagent, produced by Wako Pure Chem. Ind., Ltd.) into the polymer particle dispersion liquid so that the electric conductivity of the polymer particle dispersion liquid is 2.5 to 3.0 mS, the electric conductivity of the polymer particle dispersion liquid (the electric conductivity at the start of measurement) is measured. Then, 0.5 ml of a 0.1 N of hydrochloric acid (special grade reagent, produced by Wako Pure Chem. Ind., Ltd.) is added to the polymer particle dispersion liquid, and the electric conductivity is measured after 30 seconds. This operation is repeated at an interval of 30 seconds until the electric conductivity of the polymer particle dispersion liquid is higher than the electric conductivity at the start of the measurement.

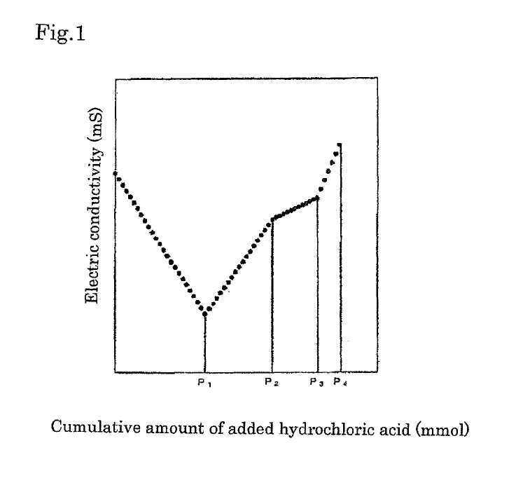

A graph having three inflection points, which is shown in FIG. 1, is obtained by plotting the electric conductivity (mS) on the Y coordinate and plotting the cumulative amount (mmol) of hydrochloric acid added on the X coordinate. The values of the abscissa at the three inflection points are referred to as P1, P2 and P3, in the increasing order, and P4 is hydrochloric acid amount of which the addition was completed. Approximate lines L1, L2, L3 and L4 are obtained from the data of segments from O to P1, segments from P1 to P2, segments from P2 to P3 and segments from P3 to P4 by the least square method, respectively. The x coordinate of the intersection point of L1 and L2, the x coordinate of the intersection point of L2 and L3 and the x coordinate of the intersection point of L3 and L4 are defined as A1 (mmol), A2 (mmol) and A3 (mmol), respectively. The amount of surface acid groups per 1 g of a copolymer constituting polymer particles contained in the polymer particle dispersion liquid is determined by the expression shown below.

The amount of surface acid groups per 1 g of polymer particles (mmol/g)=A2−A1

### Example 1

### The Production of Binder

Into a pressure-resistant container of 5 MPa with a stirrer, 46 parts of styrene, 49 parts of 1,3-butadiene, parts of methacrylic acid, 5 parts of sodium dodecylbenzenesulfonate, 150 parts of ion-exchange water and 1 part of potassium persulfonate as a polymerization initiator were added, and sufficiently stirred, followed by heating to 50° C. to start polymerization. When the amount of consumed monomer reached 95.0%, the container was cooled to stop the reaction to obtain a diene polymer particle dispersion liquid (the number average particle diameter of the polymer particles: 100 nm, the glass transition temperature of the polymer particles: −15° C.), which has a solid portion concentration of 40%, as a binder. Note that, the monomer composition used for obtaining the diene polymer particles contains 5 wt % of a monocarboxylic acid monomer (methacrylic acid) and the amount of surface acid groups per 1 g of polymer particles was 0.30 mmol.

### (The Production of Lithium Ion Secondary Battery Negative Electrode Slurry Composition)

As the thickening agent, carboxymethylcellulose (CMC, “BSH-12”, produced by Dai-Ichi Kogyo Seiyaku Co., Ltd.) was used. The degree of polymerization and a degree of thickening agent has was 1700, and the degree of etherification was 0.65.

Into a planetary mixer with a disperser, 100 parts of synthetic graphite (average particle diameter: 24.5 μm, distance between graphite layers (the interplanar spacing (d value) of the (002) plane as determined by an X-ray diffraction method): 0.354 nm) as a negative electrode active material, and 1 part of a 1% aqueous solution of the thickening agent were added and the solid portion concentration was adjusted to 55% with ion-exchange water, followed by mixing at 25° C. for 60 minutes. Next, the solid portion concentration was adjusted to 52%, followed by further mixing at 25° C. for 15 minutes to obtain a mixture solution.

Into the mixture solution, 1 part (on the solid portion basis) of the binder and ion-exchange water were added and the final solid portion concentration is adjusted to 42%, followed by further mixing for 10 minutes. Then, this was carried out with defoaming treatment to obtain a lithium ion secondary battery negative electrode slurry composition having excellent fluidity.

### (The Production of Battery)

The lithium ion secondary battery negative electrode slurry composition was applied onto a copper foil with a thickness of 20 μm with a comma coater so that the film thickness after drying is approximately 200 μm. The resulting film is dried for 2 minutes (at a rate of 0.5 m/m, 60° C.), followed by carrying out the heat treatment (120° C.) to obtain an electrode original plate. The electrode original plate was rolled by a roll press to obtain a lithium ion secondary battery negative electrode having the thickness of the negative electrode active material of 80 μm. The evaluation results of the peeling strength of the negative electrode are shown in Table 1.

The negative electrode was cut out into a disk shape with a diameter of 15 mm. A separator composed of a porous disk-shaped film made of polypropylene with a diameter of 18 mm and a thickness of 25 μm, metallic lithium and expanded metal were stacked on the surface side of the resulting negative electrode active material layer in this order, followed by placing in a coin-type packaging container equipped with a packing made of polypropylene (diameter: 20 mm, height: 1.8 mm, stainless steel thickness: 0.25 mm). The electrolytic solution was injected into the container so that air is not remained. The packaging container is fixed by covering with a cap made of stainless steel with a thickness of 0.2 mm via a polypropylene packing, followed by sealing a battery can to prepare a half-cell having a diameter of 20 mm and a thickness of approximately 2 mm.

Further, as the electrolytic solution, a solution obtained by dissolving LIPF₆ at a concentration of 1 mol/L in a mixed solvent obtained by mixing ethylene carbonate (EC) and diethyl carbonate (DEC) in a ratio of EC:DEC=1:2 (volume ratio at 20° C.) was used. The evaluation results of performance of the half-cell (lithium ion secondary battery) are shown in Table 1.

### Example 2

A slurry composition, a negative electrode and a half-cell were prepared and evaluated by carrying out the same procedures as in Example 1 except for changing the thickening agent to carboxymethylcellulose having a degree of polymerization of 1420 and a degree of etherification of 0.7 in Example 1. The results are shown in Table 1.

### Example 3

### The Production of Binder

Into a pressure-resistant container of 5 MPa with a stirrer, 50 parts of styrene, 48.5 parts of 1,3-butadiene, 1.5 parts of methacrylic acid, 5 parts of sodium dodecylbenzenesulfonate, 150 parts of ion-exchange water and 1 part of potassium persulfonate as a polymerization initiator were added and sufficiently stirred, followed by heating to 50° C. to start polymerization. When the amount of consumed monomer reached 95.0%, the container was cooled to stop the reaction to obtain a diene polymer particle dispersion liquid (the number average particle diameter of the polymer particles: 105 nm, the glass transition temperature of the polymer particles: −18° C.), having a solid portion concentration of 40% as a binder. Note that, the monomer composition used for obtaining the diene polymer particles contains 1.5 wt % of a monocarboxylic acid monomer (methacrylic acid) and the amount of surface acid groups per g of polymer particles was 0.11 mmol.

A slurry composition, a negative electrode and a half-cell were prepared and evaluated by carrying out the same procedures as in Example 1 except for using the above binder. The results are shown in Table 1.

### Example 4

### The Production of Binder

Into a pressure-resistant container of 5 MPa with a stirrer, 47 parts of styrene, 45 parts of 1,3-butadiene, parts of methacrylic acid, 5 parts of sodium dodecylbenzenesulfonate, 150 parts of ion-exchange water and 1 part of potassium persulfonate as a polymerization initiator were added and sufficiently stirred, followed by heating to 50° C. to start polymerization. When the amount of consumed monomer reached 95.0%, the container was cooled to stop the reaction to obtain a diene polymer particle dispersion liquid (the number average particle diameter of the polymer particles: 110 nm, the glass transition temperature of the polymer particles: 4° C.) having a solid portion concentration of 40% as a binder. Note that, the monomer composition used for obtaining the diene polymer particles contains 8 wt % of a monocarboxylic acid monomer (methacrylic acid) and the amount of surface acid groups per 1 g of polymer particles was 0.76 mmol.

A slurry composition, a negative electrode and a half-cell were prepared and evaluated by carrying out the same procedure as in Example 1 except for using the above binder. The results are shown in Table 1.

### Example 5

### The Production of Binder

Into a pressure-resistant container A with a stirrer, 12 parts of butyl acrylate, 0.4 parts of acrylonitrile, 0.05 parts of sodium laurylsulfate and 70 parts of ion-exchange water were added. The container A was heated to 48° C. and 0.2 parts of ammonium persulfonate was added, followed by stirring for 120 minutes. An emulsion was prepared by adding and stirring 82 parts of butylacrylate, 2.6 parts of acrylonitrile, 3 parts of methacrylic acid, 0.2 parts of sodium laurylsulfate and 30 parts of ion-exchange water into a separate pressure-resistant container B with a stirrer. The emulsion was continuously added into the pressure-resistant container A over approximately 420 minutes and heated to 60° C., followed by stirring for approximately 300 minutes. When the amount of consumed monomer reached 95%, the container was cooled to stop the reaction to obtain an acrylic polymer particle dispersion liquid (the number average particle diameter of the polymer particles: 360 nm, the glass transition temperature of the polymer particles: −35° C.) having a solid portion concentration of 40% as a binder.

Note that, the monomer composition used for obtaining the acrylic polymer particles contains 3 wt % of a monocarboxylic acid monomer (methacrylic acid) and the amount of surface acid groups per 1 g of polymer particles was 0.18 mmol.

A slurry composition, a negative electrode and a half-cell were prepared and evaluated by carrying out the same procedures as in Example 1 except for using the above binder. The results are shown in Table 1.

### Example 6

A slurry composition, a negative electrode and a half-cell were prepared and evaluated by carrying out the same procedures as in Example 1 except for changing the thickening agent to carboxymethylcellulose having a degree of polymerization of 2700 and a degree of etherification of 0.7 in Example 1. The results are shown in Table 1.

### Comparative Example 1

### The Production of Binder

Into a pressure-resistant container of 5 MPa with a stirrer, 200 parts of ion-exchange water, 0.5 parts of sodium laurylsulfate, 1.0 part of potassium persulfate, 0.5 parts of sodium bisulfite, 30 parts of styrene, 38 parts of 1,3-butadiene, 30 parts of methyl methacrylate, 3 parts of itaconic acid and 0.1 parts of α-methylstyrene dimer were added, followed by allowing to react at 45° C. for 6 hours. Thereafter, the polymerization was continued by continuously adding a mixture of 45 parts of styrene, 24 parts of 1,3-butadiene, 20 parts of methyl methacrylate, 3.5 parts of itaconic acid and 0.2 parts of α-methylstyrene dimer at 60° C. for 7 hours, and after the continuous addition is completed, the reaction was continued at 70° C. over 6 hours to obtain a product. The resulting product was deodorized and concentrated to obtain a diene polymer particle dispersion liquid (the number average particle diameter of the polymer particles: 120 nm, the glass transition temperature of the polymer particles: 1° C.) having a solid portion concentration of 40%, as a binder. In addition, the monomer composition used for obtaining the diene polymer particles contains 3. wt % of a dicarboxylic acid monomer (itaconic acid) and the amount of surface acid groups per g of polymer particles was 1.12 mmol.

A slurry composition, a negative electrode and a half-cell were prepared and evaluated by carrying out the same operations as in Example 1 except for using the above binder. The results are shown in Table 1.

### Comparative Example 2

A slurry composition, a negative electrode and a half-cell were prepared and evaluated by carrying out the same procedures as in Example 1 except for changing the thickening agent to carboxymethylcellulose having a degree of polymerization of 1100 in Example 1. The results are shown in Table 1.

### Comparative Example 3

### The Production of Binder

Into a pressure-resistant container of 5 MPa with a stirrer, 50 parts of styrene, 35 parts of 1,3-butadiene, parts of methacrylic acid, 5 parts of sodium dodecylbenzenesulfonate, 150 parts of ion-exchange water and 1 part of potassium persulfonate as a polymerization initiator were added and t sufficiently stirred, then heated to 50° C. to start polymerization. When the amount of consumed monomer reached 95.0%, the container was cooled to stop the reaction to obtain a diene polymer particle dispersion liquid (the number average particle diameter of the polymer particles: 130 nm, the glass transition temperature of the polymer particles: 25° C.) having a solid portion concentration of 40%, as a binder. Note that, the monomer composition used for obtaining the diene polymer particles contains 15 wt % of a monocarboxylic acid monomer (methacrylic acid) and the amount of surface acid groups per g of polymer particles was 1.41 mmol.

A slurry composition, a negative electrode and a half-cell were prepared and evaluated by carrying out the same procedures as Example 1 except for using the above binder. The results are shown in Table 1.

### Comparative Example 4

Into a pressure-resistant container with a stirrer, parts of ion-exchange water, 0.15 parts of sodium dodecyl diphenyl ether disulfonate (Pelex SS-L, produced by KAO Corporation), 0.7 parts of t-dodecyl mercaptan, 0.35 parts of potassium persulfate, 35 parts of 1,3-butadiene, 34.5 parts of styrene and 0.5 parts of methacrylic acid were added, followed by stirring to obtain an emulsion of a monomer mixture at the first stage.

Into a separate pressure-resistant container with a stirrer, 0.09 parts of sodium dodecyldiphenyl ether disulfonate, 0.3 parts of t-dodecyl mercaptan, 0.15 parts of potassium persulfonate, 15 parts of 1,3-butadiene, 14.5 parts of styrene and 0.5 parts of methacrylic acid were charged, followed by stirring to obtain an emulsion of a monomer mixture at the second stage.

Into a pressure-resistant container with a stirrer, parts of ion-exchange water, 0.71 parts of sodium dodecyldiphenyl ether disulfonate were added and stirred to obtain a mixture. The obtained mixture was heated at 80° C. and the emulsion of a monomer mixture at the first stage was continuously added to the obtained mixture over 250 minutes. Immediately after completing of the continuous addition, the polymerization conversion rate was 85% with respect to the total amount of the monomer mixture at the first stage. Next, the emulsion of a monomer mixture at the second stage was continuously added into the pressure-resistant container over 90 minutes. After completing of the addition, the pressure-resistant container was heated to 85° C. and further the reaction was continued for 5 hours. Then, when the amount of consumed monomer reached 95%, the container was cooled to stop the reaction and 0.5 parts of a sodium nitrite aqueous solution (5%) was added to stop the polymerization to obtain a diene polymer particle dispersion liquid (the number average particle diameter of the polymer particles, 110 nm, the glass transition temperature of the polymer particles: −3° C.) having a solid portion concentration of 40%, as a binder.

Note that, the monomer composition used for obtaining the diene polymer particles contains 1.0 wt % of a monocarboxylic acid monomer (methacrylic acid) and the amount of surface acid groups per 1 g of polymer particles was 0.08 mmol.

A slurry composition, a negative electrode and a half-cell were prepared and evaluated by carrying out the same operations as in Example 1 except for using the above binder. The results are shown in Table 1.

### Comparative Example 5

### The Production of Binder

Into a pressure-resistant container of 5 MPa with a stirrer, 50 parts of styrene, 50 parts of 1,3-butadiene, 5 parts of sodium dodecylbenzenesulfonate, 150 parts of ion-exchange water and 1 part of potassium persulfonate as a polymerization initiator were added and sufficiently stirred, then heated to 50° C. to start polymerization. When the amount of consumed monomer reached 95.0%, the container was cooled to stop the reaction to obtain a diene polymer particle dispersion liquid (the number average particle diameter of the polymer particles: 120 nm, the glass transition temperature of the polymer particles: 18° C.) having a solid portion concentration of 40%, as a binder.

A slurry composition, a negative electrode and a half-cell were prepared and evaluated by carrying out the same procedures as in Example 1 except for using the above binder. The results are shown in Table 1.

TABLE 1

| | Binder | | | | | | | | |
|---|---|---|---|---|---|---|---|---|---|
| | | | The content | The content of the | | | | | |
| | | | of the acid | monocarboxylic | The amount | | Evalucation | | |
| | | | component | acid | of the acid | | | | The |
| | | | in the | monomer in | group on the | The degree of | | | charge |
| | Type | | monomer | the monomer | surface per 1 g | polymerization of | The | The low | discharge |
| | of the | | composition | composition | of the polymer | the thicknening | peel | temperature | cycle |
| | polymer | Type of the acid | (wt. %) | (wt. %) | particle (mmol) | agent | strength | characteristic | characteristic |
| Example 1 | diene | monocarboxylic | 5 | 5 | 0.3 | 1,700 | A | A | A |
| | | acid | | | | | | | |
| Example 2 | diene | monocarboxylic | 5 | 5 | 0.3 | 1,420 | C | B | C |
| | | acid | | | | | | | |
| Example 3 | diene | monocarboxylic | 1.5 | 1.5 | 0.11 | 1,700 | D | C | C |
| | | acid | | | | | | | |
| Example 4 | diene | monocarboxylic | 8 | 8 | 0.76 | 1,700 | B | C | B |
| | | acid | | | | | | | |
| Example 5 | acrylic | monocarboxylic | 3 | 3 | 0.18 | 1,700 | B | A | B |
| | | acid | | | | | | | |
| Example 6 | diene | monocarboxylic | 5 | 5 | 0.3 | 2,700 | A | B | B |
| | | acid | | | | | | | |
| Comparative | diene | dicarboxylic acid | 3.4 | 0 | 1.12 | 1,700 | B | E | D |
| example 1 | | | | | | | | | |
| Comparative | diene | monocarboxylic | 5 | 5 | 0.3 | 1,100 | F | D | F |
| example 2 | | acid | | | | | | | |
| Comparative | diene | monocarboxylic | 15 | 15 | 1.41 | 1,700 | D | E | F |
| example 3 | | acid | | | | | | | |
| Comparative | diene | monocarboxylic | 1.0 | 1.0 | 0.08 | 1,700 | E | D | E |
| example 4 | | acid | | | | | | | |
| Comparative | diene | — | 0 | 0 | — | 1,700 | F | E | F |
| example 5 | | | | | | | | | |

From the results of Table 1, the following conclusions can be drawn.

A lithium ion secondary battery negative electrode slurry composition comprises a negative electrode active material, a thickening agent, a binder composed of polymer particles and water, wherein the lithium ion secondary battery has excellent balance between the peeling strength (adhesion strength) of a negative electrode and low-temperature characteristics and the charge and discharge cycle characteristics (life characteristics) of the lithium ion secondary battery by using the lithium ion secondary battery negative electrode slurry composition in which the negative electrode active material contains a carbon material having a graphite interlayer distance (an interplanar spacing (d value) of the (002) plane as determined by an X-ray diffraction method) of 0.340 to 0.370 nm, the thickening agent is a polymer having a degree of polymerization of 1400 to 3000, and the polymer particles are obtained by polymerizing a monomer composition containing 1 to 10 wt % of a monocarboxylic acid monomer and in which the amount of acid groups on the surface of the polymer particles as determined by conductivity titration is 0.10 to 1.0 mmol per g1 of the polymer particles (Examples 1 to 6).

1. A lithium ion secondary battery negative electrode slurry composition comprising a negative electrode active material, a thickening agent, a binder of polymer particles and water, wherein the negative electrode active material includes a carbon material and the carbon material has a graphite interlayer distance (an interplanar spacing (d value) of the (002) plane as determined by an X-ray diffraction method) of 0.340 to 0.370 nm, the thickening agent is a polymer having a degree of polymerization of 1400 to 3000, the polymer particles are obtained by polymerizing a monomer composition including 1 to 10 wt % of a monocarboxylic acid monomer, and an amount of acid groups on the surface of the polymer particles as determined by a conductivity titration is 0.1 to 1.0 mmol per 1 g of the polymer particles.

2. The lithium ion secondary battery negative electrode slurry composition according to claim 1, wherein the thickening agent is an anionic cellulose polymer having a degree of etherification of 0.5 to 1.5.

3. The lithium ion secondary battery negative electrode slurry composition according to claim 1, wherein the polymer particles are diene polymer or acrylic polymer.

4. A lithium ion secondary battery negative electrode prepared by coating a lithium ion secondary battery negative electrode slurry composition according to claim 1 onto a current collector; then by drying.

5. A lithium ion secondary battery comprising a positive electrode, a negative electrode, a separator and an electrolytic solution, wherein the negative electrode is the lithium ion secondary battery negative electrode according to claim 4.

6. The lithium ion secondary battery negative electrode slurry composition according to claim 2, wherein the polymer particles are diene polymer or acrylic polymer.

7. A lithium ion secondary battery negative electrode prepared by coating a lithium ion secondary battery negative electrode slurry composition according to claim 2 onto a current collector; then by drying.

8. A lithium ion secondary battery negative electrode prepared by coating a lithium ion secondary battery negative electrode slurry composition according to claim 3 onto a current collector; then by drying.

9. A lithium ion secondary battery comprising a positive electrode, a negative electrode, a separator and an electrolytic solution, wherein the negative electrode is the lithium ion secondary battery negative electrode according to claim 7.

10. A lithium ion secondary battery comprising a positive electrode, a negative electrode, a separator and an electrolytic solution, wherein the negative electrode is the lithium ion secondary battery negative electrode according to claim 8.
